(19) United States
(12) Patent Application Publication
(10) Pub. No.: US 2022/0261747 A1
(43) Pub. Date: Aug. 18, 2022

(54) SYSTEM AND METHOD FOR SELF-DELIVERY OF MICRO-BREWED BEER

(71) Applicant: Eric Schubert, New Boston, MI (US)

(72) Inventor: Eric Schubert, New Boston, MI (US)

(21) Appl. No.: 17/674,594

(22) Filed: Feb. 17, 2022

Related U.S. Application Data
(60) Provisional application No. 63/150,902, filed on Feb. 18, 2021.

(51) Int. Cl. G06Q 10/08; B60W 60/00; G05D 1/00; G05D 1/02; G06V 40/16

(52) U.S. Cl. CPC G06Q 10/0832; G06Q 10/087; G06Q 10/0833; B60W 60/00256; B60W 2556/50; G05D 1/0217; G06V 40/172; G05D 2201/0216; G05D 1/0088

(57) ABSTRACT

A system and method for the self-delivery of micro-brewed beer in disclosed. In this context, micro-brewed beer refers to jurisdictionally-imposed volumetric limitations imposed on a brewer. Self-delivery refers to delivery made by the micro-brewer. The overall method identifies a suitable jurisdiction; brews a volume of beer that does not exceed the maximum volume of beer dictated by the jurisdiction; creates a service area within the jurisdiction; locates a refrigerated storage facility in the service area; distributes beer to the refrigerated storage facility; and delivers the beer from the storage facility to consumers using a refrigerated vehicle.

### FIELD OF INVENTION

This invention relates to the classification for data processing systems and methods, specifically adapted for commercial purposes and one or more sub-classifications for logistics; and buying, selling or leasing transactions. Specifically, this invention is a system and method for the self-delivery of micro-brewed beer.

### BACKGROUND OF INVENTION

Delivery of beer in the United States is usually highly legislated and regulated at both the federal and state level, with many laws specifically designed to add cost of the final product to the consumer. The theory being that a higher cost to the consumer will reduce overall, statewide consumption. This is a remnant of the moralism left over from the Prohibition Era. Beer delivery laws are an anomaly in the current day. Beer delivery laws typically outlaw the delivery of beer in any manner other than those specifically allowed by law.

In most states, the delivery of beer is still controlled by a tightly limited number of distributors, by law. The result is typically an antiquated, three-tiered delivery system. The typical three-tier system means that breweries must first sell to a distributor who then marks up the beer and sells it to a retailer (20-25% markup) who then marks up the beer for final sale to end users (another 20-25% markup). If a delivery service offers to deliver a product to a customer then they will usually add a mark up to the product and more than likely a delivery charge so the final delivered price will be nearly double the original wholesale price charged by the brewer.

The result of the typical three-tier delivery system is a lack of choice at an elevated price. The large beer producers in the United States, Anheuser Busch, Miller Coors for example, have a de facto monopoly on shelf space at retailers and supply to restaurants and bars. This inhibits the ability of small, craft brewers to effectively distribute their product and penetrate the market.

The homebrew industry was a direct outgrowth of the limitations of choice and price imposed by the antiquated beer distribution system. In responding to the market forces pushing for homebrew legislation, most states allow micro-brewing of some sort. Micro-brew legislation typically limits the annual sales of beer in some manner, for example, a volumetric limit on the annual sale of beer. Some of the micro-brew legislation allows for micro-brewers to self-distribute.

Although no one is currently offering a direct-to-consumer home delivery service for micro-brewers, the enabling legislation of many states no longer prohibits the direct-to-consumer home delivery of micro-brewed beer. The market has a real need and desire for a direct-to-consumer home delivery system and method for micro-brewed beer, that successfully navigates the beer distribution limitations imposed by each of the fifty states.

### SUMMARY

This summary is intended to disclose a system and method for the self-delivery of micro-brewed beer. In this context, self-delivery means delivery by the micro-brewer, itself. Micro-brewer refers to a brewer of beer that cannot exceed jurisdictionally-imposed volumetric limits.

The embodiments and descriptions are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

The consumer-looking end of this invention is deceptively simple. A customer submits their orders using an app on their mobile phone or laptop. The app provides location-based feedback, showing the customer the proximity of the closest delivery vehicle. The delivery vehicle would drive to the customer's address. The customer can watch as the vehicle makes progress towards its destination. The app will also show the estimated arrival time and send a message when the delivery vehicle arrives.

From the delivery-vehicle-looking end, this invention is also simple. An onboard electronic device, such as a driver cellphone, will have a delivery vehicle app. A cellular connection will automatically alert the onboard electronic device upon receiving a beer delivery request. The delivery vehicle app will route the vehicle directly to the customer's delivery location. The delivery vehicle app must take care in certain places not to route the delivery vehicle over state lines, when such navigation is unlawful. For although the delivery is legal in one jurisdiction, it may not be legal in an adjoining jurisdiction, and the delivery vehicles must be routed in a way that respects territorial jurisdictions.

From a delivery vantage-point, this invention is logistics intensive. The micro-brewer establishes a micro-brewery in accordance with the volumetric limitations imposed by state law. The micro-brewery brews beer without exceeding the volume limitations imposed by state law. The micro-brewery identifies cities and towns within which it will offer its home-delivery service, creating service areas. The micro-brewery establishes a network of refrigerated storage depots that can economically serve the service areas. The micro-brewery uses a fleet of GPS-enabled, refrigerated vehicles to service the service areas by collecting a stock of refrigerated beer from a designated refrigerated storage depot and distributing the beer in accordance with the user and delivery vehicle applications noted above.

The system and method of this invention require a jurisdiction that has a volumetric limit for the self-delivery of micro-brewed beer, a defined service area, a plurality of user electronic devices, a plurality of GPS-enabled, refrigerated vehicles outfitted with an onboard electronic device, a plurality of refrigerated storage depots, a delivery server, and one or more micro-brewing locations. Each user electronic device needs an input and an output; a transmitter; a receiver; a non-transitory, computer-readable memory element; a processor; and a computer-executable instruction set, stored on the non-transitory, computer-readable memory element, which can be executed by the processor upon receiving input from a user in order to generate a beer delivery request and transmit it to a delivery server.

The delivery server needs a transmitter, a receiver, a non-transitory, computer-readable memory element; a processor; and a computer-executable instruction set, stored on the non-transitory, computer-readable memory element, which can be executed by the processor upon receiving a beer delivery request from a user, comparing the beer delivery request address with the defined service area, identifying a refrigerated vehicle most capable of fulfilling the beer delivery request, and transmitting the beer delivery request to the identified refrigerated vehicle.

Each refrigerated vehicle must contain a refrigerated compartment suitable for storing and transporting beer. The onboard electronic device needs an input and an output; a transmitter; a receiver; a global-positioning system (“GPS”) chipset; a non-transitory, computer-readable memory element; a processor; and a computer-executable instruction set, stored on the non-transitory, computer-readable memory element, which can be executed by the processor upon receiving a beer delivery request from the delivery server, identifying the delivery address, legally routing the delivery vehicle to the delivery address, and providing the user with the beer ordered in the beer delivery request.

The overall method would be identifying a suitable jurisdiction for delivery by ascertaining the maximum volume of beer that may be self-delivered; brewing a volume of beer that does not exceed the maximum volume of beer dictated by the jurisdiction; creating a service area within the jurisdiction; locating a refrigerated storage facility in a logistically suitable geographic region so as to adequately service the service area; distributing beer to the refrigerated storage facility; using a GPS-enabled, refrigerated delivery vehicle, having a refrigerated beer-storage compartment; loading beer from the refrigerated storage facility into the refrigerated beer-storage compartment of the GPS-enabled, refrigerated delivery vehicle; staging the GPS-enabled, refrigerated delivery vehicle in a logistically appropriate place; enabling users within the service area to order micro-brewed beer to be delivered to an address within the service area; verifying that a user is eligible to receive micro-brewed beer based on age, address, and payment status; routing the GPS-enabled, refrigerated delivery vehicle to the address, using only road networks contained in the jurisdiction; arriving at the address; delivering beer to the user at the address; and tracking the aggregate amount of beer so delivered.

The method may optionally comprise the additional steps of providing real-time feedback to the user, identifying the current position of the GPS-enabled delivery vehicle; using a driver to drive the GPS-enabled delivery vehicle; using an autonomous GPS-enabled delivery vehicle; using facial recognition to verify that the person receiving the delivery at the address is the verified user; creating compliance reports for jurisdictional authorities, showing compliance with all applicable beer distribution laws; providing real-time information concerning the temperature of the refrigerated beer-storage compartment of the GPS-enabled, refrigerated delivery vehicle; and collecting, monitoring, and assessing diagnostic information related to the GPS-enabled, refrigerated delivery vehicle.

Diagnostic information related to the GPS-enabled, refrigerated delivery vehicle can be one or more of tracking the service miles and service hours of the GPS-enabled, refrigerated delivery vehicle; tracking the fuel economy of the vehicle; tracking the engine temperature of the vehicle; creating a preventative maintenance schedule for the GPS-enabled, refrigerated delivery vehicle based on one or more of a control chart of the temperature of the refrigerated beer-storage compartment, the service hours, and the service miles; and executing a preventative maintenance schedule on the GPS-enabled refrigerated delivery vehicle.

The user electronic device will have an app. The app will allow the user to create beer delivery requests. The beer delivery requests will be transmitted to a delivery server. The delivery server will verify the eligibility of the user based on the user's age, identify, address, and ability to pay. A person will have to show an identification that confirms their age. A person will also have to provide payment information, such as a valid credit or debit card, or a payment service such as PayPal, Venmo, or CashApp. The delivery server will transmit eligible requests to a GPS-enabled, refrigerated delivery vehicle. Meaning that before a beer delivery request is forwarded to the GPS-enabled, refrigerated delivery vehicle, the user's age and payment has been verified.

The GPS-enabled, refrigerated delivery vehicle will be staged at a logistically advantageous position. A logistically advantageous position can be determined in a number of ways. A logistically advantageous position can be the centroid of past sales for a particular service area. A logistically advantageous position can be the minimum time to travel on expected future orders, based on population density. A logistically advantageous position can be a centroid of the population for the service area. A logistically advantageous position can be the minimum time to travel to prior delivery addresses, based on a weighting of their order frequency. A logistically advantageous position can be calendar specific, such as placing vehicles near universities when the students return. A logistically advantageous position can be determined using demographic information from past sales, such as age, sex, and median income, and mapping it onto demographic information for the geographic service area as a whole.

The graphic user interface (“GUI”) on the end-user electronic device can provide engagement and information intended to gamify the purchase of beer. Engagement can be driven with things like a loyalty program, rewarding the user for frequent beer purchases. Engagement can also be information-driven, providing the user with things like their previous order history. Engagement can also be promotion driven, informing the user of current and up-coming promotional offers. The delivery application will show the current location of the user's delivery. The delivery application will provide an estimated time of arrive. The delivery application will provide a delivery notification, telling the user that their delivery is on-site. The delivery application can provide auxiliary data, such as temperature of the beer storage compartment on the delivery vehicle, the ambient outdoor temperature, the average price of beer in the local area, the average delivery time in the local area for the micro-brewer's service, and trivia related to the micro-brewer, beer, and the local service area.

The routing of the service vehicle will take into account limitations imposed by state law. For example, the delivery vehicles will not cross state lines in order to deliver beer, without first confirming that such inter-state travel in delivering beer is legal.

For the micro-brewer, the method will track the aggregate annual sales. If sales indicate that the micro-brewer will exceed jurisdictional volume limitations, the application can provide feedback concerning adjustments to service areas, pricing, and product offering that will be designed to level-load the demand.

### DESCRIPTION OF THE DRAWINGS

The present invention is illustrated with 8 figures on 6 sheets. The accompanying drawings, which are incorporated in and constitute a part of this disclosure, illustrate various example embodiments. Additional drawings and figures are possible based on the disclosure.

In the drawings:

FIG. 1 depicts a user with a user electronic device.

FIG. 2 shows an example of location-based feedback that is given to the user with this invention.

FIG. 3 shows a GPS-enabled, refrigerated delivery vehicle with a refrigerated beer storage compartment.

FIG. 4 shows a jurisdiction, in this case Ohio; and service areas, in this case Toledo, Cleveland, Youngstown, Columbus, Cincinnati, Dayton, and Akron.

FIG. 5 is a flowchart of the overall method.

FIG. 6 is a typical communication diagram.

FIG. 7 is a system diagram.

FIG. 8 is a flowchart of the ordering process.

### DETAILED DESCRIPTION

The following descriptions are not meant to limit the invention, but rather to add to the summary of invention, and illustrate the present invention, a system and method for the self-delivery of micro-brewed beer. The present invention is illustrated with a variety of drawings showing the primary embodiment of the present invention, with examples presented showing various aspects of the invention and its implementations.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

FIG. 1 shows a user 100 inputting 20 a beer order for self-delivery of micro-brewed beer using an end-user electronic device 10. The end-user electronic device 10 typically has a touch-screen, allowing for inputting 20 with the user's 100 hands 20.

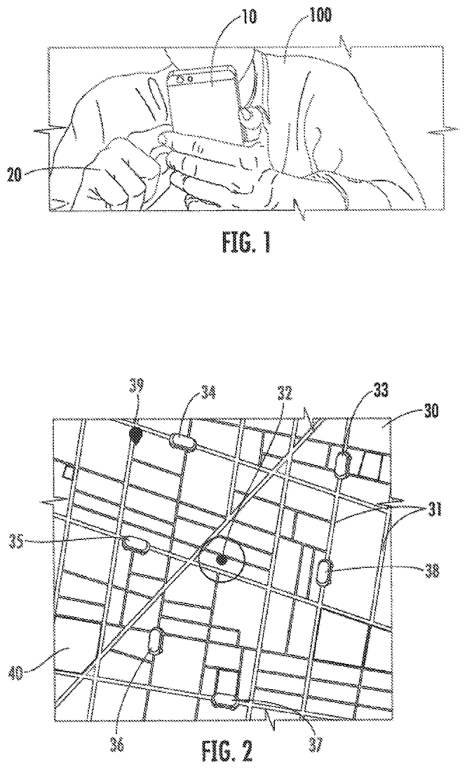

As shown in FIG. 2, once entered, the user 100 can monitor the progress of their order on a graphic user interface (“GUI”) 30 visible on the end-user electronic device 10. The GUI 30 displays a limited geographic region 40, containing a plurality of roads 31. The location 32 of the user 100 would be centered on the GUI 30 in default operation, although the user 100 could pan the geographic region 40 using the input 20 of the GUI 30 on the end-user electronic device 10. The GUI also shows the beer depot 39, a refrigerated storage facility for the beer 39, and a plurality of refrigerated delivery vehicles 33, 34, 35, 36, 37, 38. One of the plurality of refrigerated delivery vehicles 33, 34, 35, 36, 37, 38, for example 35, could be highlighted on the GUI 30 in order to indicate it was the vehicle destined for the location 32 of the user 100. Due to laws about delivery of alcoholic beverages and the need to verify that the purchaser is of-age, the invention requires that the user 100 be at the delivery address 32 for the beer.

FIG. 3 shows an example of a GPS-enabled, refrigerated vehicle 200. The GPS-enabled, refrigerated vehicle 200 has a refrigeration unit 202, a cargo compartment 201 for the beer, and a driver cabin 203.

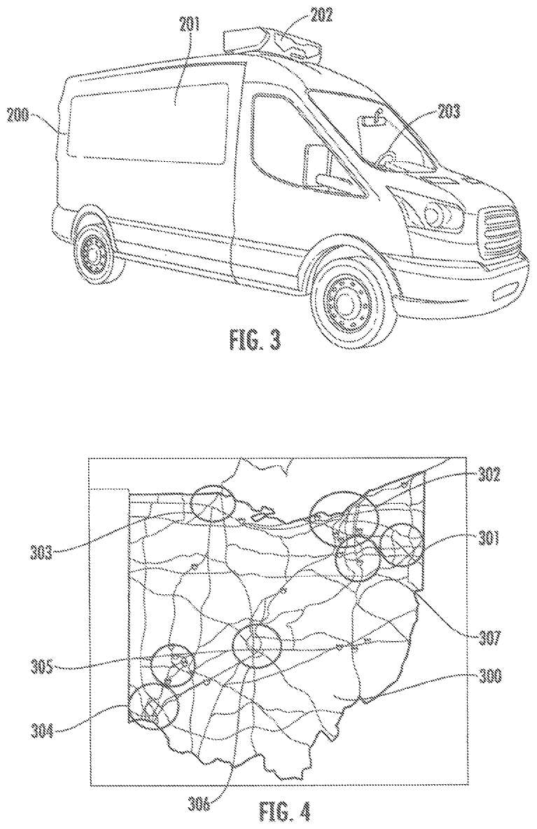

As shown in FIG. 4, the present invention, a system and method for the self-delivery of micro-brewed beer, would be confined to a specific jurisdiction 300, such as a state 300. A micro-brewer, interested at self-delivery within a jurisdiction 300, would locate a plurality of service areas 301, 302, 303, 304, 305, 306, 307. Service areas 301, 302, 303, 304, 305, 306, 307 would be located in areas with high population densities, such as the largest cities and towns 301, 302, 303, 304, 305, 306, 307 within a state 300.

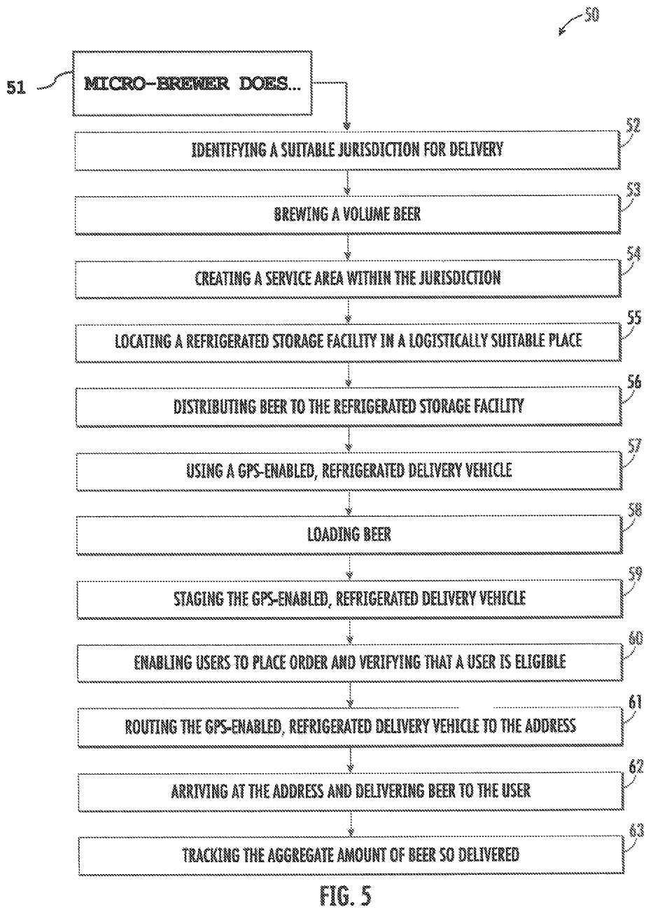

FIG. 5 is a flow-chart showing the primary method 50 of the present invention, performed by the micro-brewer 51. A micro-brewer 51 begins by identifying a suitable jurisdiction for self-delivery 52. The micro-brewer's selection of a suitable jurisdiction would be based on the maximum amount of beer that can be brewed and self-delivered. The micro-brewer establishes a micro-brewery in accordance with the volumetric limitations imposed by state law.

The micro-brewery brews a volume of beer 53, without exceeding the volume limitations imposed by state law.

The micro-brewer creates defined service areas within the jurisdiction 54. The micro-brewer does this by identifying cities and towns, based on population and population density, within which it will offer its home-delivery service.

The micro-brewer locates a refrigerated storage facility 39 in a logistically suitable place 55 for each service area 301, 302, 303, 304, 305, 306, 307. The micro-brewery establishes a network of refrigerated storage depots 39 that can economically serve the service areas 301, 302, 303, 304, 305, 306, 307. The micro-brewery 51 distributes beer to the refrigerated storage facility 56, 39 within each service area 301, 302, 303, 304, 305, 306, 307.

The micro-brewery uses a fleet of GPS-enabled, refrigerated vehicles 57, 200 to service the service areas 301, 302, 303, 304, 305, 306, 307. Each GPS-enabled, refrigerated vehicles 200 loads beer 58 from the beer depot 39.

Each GPS-enabled, refrigerated vehicles 200 is staged 59 in a logistically advantageous position to service its service area (e.g., 302). A logistically advantageous position can be determined in a number of ways. A logistically advantageous position can be the centroid of past sales for a particular service area. A logistically advantageous position can be the minimum time to travel on expected future orders, based on population density. A logistically advantageous position can be a centroid of the population for the service area. A logistically advantageous position can be the minimum time to travel to prior delivery addresses, based on a weighting of their order frequency. A logistically advantageous position can be calendar specific, such as placing vehicles near universities when the students return. A logistically advantageous position can be determined using demographic information from past sales, such as age, sex, and median income, and mapping it onto demographic information for the geographic service area as a whole

The micro-brewer 51 enables users 100 to place a beer order, verifying the user's eligibility 60, based off of the user's 100 age, the destination 32 of the beer delivery, the current location of the user 100 as expressed by the end-user electronic device 10, and payment.

The GPS-enabled, refrigerated vehicles 200 is routed 61 to the delivery address 32 of the user 100. The user 100 is able to monitor the progress of the delivery via a GUI 30 on the end-user electronic device 10. The GPS-enabled, refrigerated vehicles 200 arrives at the delivery address 32 and delivers the beer 62. The GPS-enabled, refrigerated vehicles 200 could be driven by a driver, or it could be autonomous. If a driver is used, the driver can verify the user's identity. Alternately, the user's 100 identify could be determined using an uploaded driver's license and facial recognition upon delivery 62. The micro-brewer 51 tracks the aggregate amount of beer so delivered 63 in order to comply with jurisdictional 300 requirements for both the volume that is allowed to be brewed and the volume that is allowed to be self-delivered.

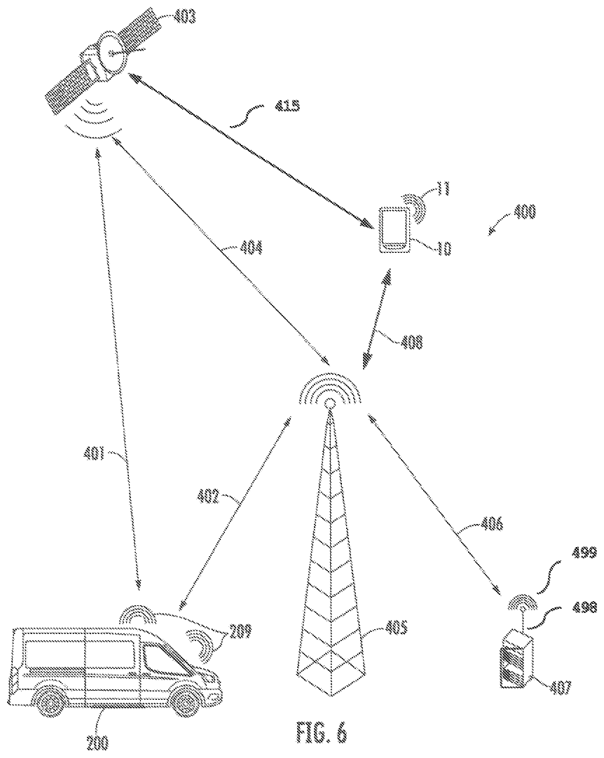

FIG. 6 shows a communication diagram of the system 400. The communication system 400 includes cellular towers 405, satellites 403, GPS-enabled, refrigerated vehicles 200, an end-user electronic device 10, the internet 498, and a delivery server 407. The end-user electronic device 10 is enabled for wireless communication 11. The GPS-enabled, refrigerated vehicles 200 is enabled for wireless communication through an onboard electronic device 209. The onboard electronic device 209 needs an input and an output; a communications chipset capable of transmitting and receiving; a global-positioning system (“GPS”) chipset; a non-transitory, computer-readable memory element; a processor; and a computer-executable instruction set, stored on the non-transitory, computer-readable memory element, which can be executed by the processor upon receiving a beer delivery request from the delivery server, identifying the delivery address, legally routing the delivery vehicle to the delivery address, and providing the user with the beer ordered in the beer delivery request. The delivery server 407 is connected to the internet 498, which is enabled for wireless communication 499.

The end-user electronic device 10 can communicate 415 with the satellites 403; the end-user electronic device 10 can communicate 408 with the cellular towers 405. The GPS-enabled, refrigerated vehicles 200 can communicate 401 with the satellites 403; the GPS-enabled, refrigerated vehicles 200 can communicate 402 with the cellular towers 405. The internet 498 can communicate 406 with the cellular towers 405, which in turn can communicate 404 with the satellites 403.

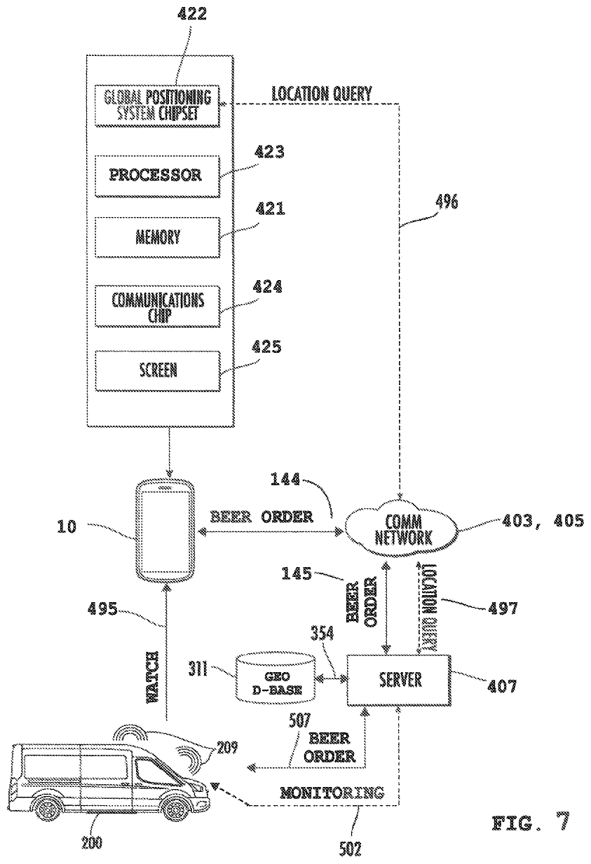

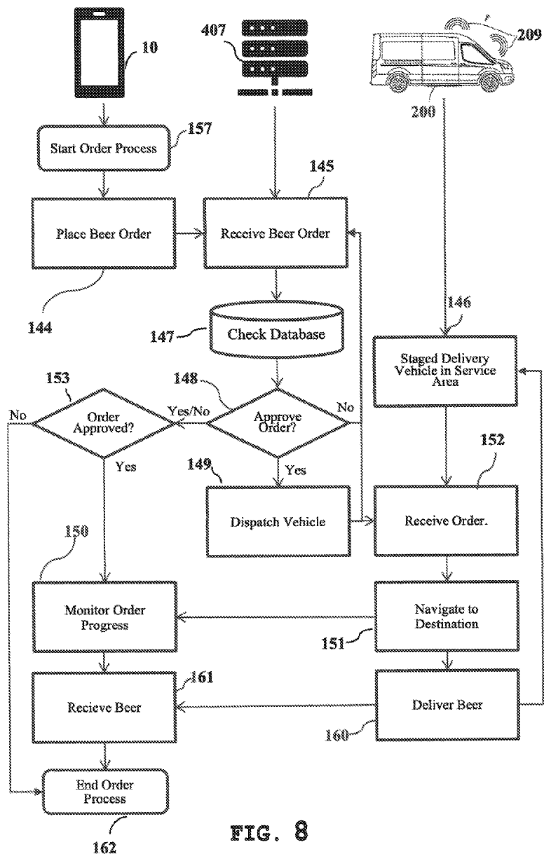

FIG. 7 shows a system 600 diagram. The system 600 is comprised of an end-user electronic device 10, GPS-enabled, refrigerated vehicle 200, a delivery server 407, a database containing geographic information for service area boundaries and jurisdiction boundaries 311, and a communications network containing satellites 403 and cellular towers 405. The end-user electronic device is comprised of a global positioning system (“GPS”) chipset 422, a processor 423, a non-transitory memory 421, a communications chipset 424, and a touch screen 425 for input 20 and output 30.

A non-transitory, computer-readable instruction set called a user app is stored on the non-transitory memory 421. When the user 100 wants to order beer, the user 100 uses the end-user electronic device 10 to do so, inputting 20 the beer order into the user app via a touch screen 425, or similar input 20 device. When the user app is initiated, the processor 423 executes the instruction set stored on the non-transitory memory 421, allowing the user to place a beer order 144. The beer order 144 is communicated 408, 415 over the communication network 403, 405. When the delivery server 407 receives 145 the beer order, it initiates a location query 497, 496 via the communications network 403, 405. The location query 497, 496 asks the end-user electronic device 10 to confirm it's GPS coordinates using its GPS chipset 422, which receive 415 signals from multiple satellites 403, allowing the GPS chipset 422 to verify its position, anywhere on the Earth, within about 12 meters.

The delivery server 407 receives the location of the end-user's electronic device 10 and compares 354 with geographic information contained in a database 311. If the delivery server 407 verifies that the user 100 is at a valid delivery destination 32, the delivery server 407 communicates 507 beer order to a GPS-enabled, refrigerated vehicle 200.

The delivery server 407 is able to monitor 502 the location of the GPS-enabled, refrigerated vehicle 200 as it heads toward the delivery destination 32. The delivery server 407 can also monitor 502 things service hours, service miles, fuel economy, engine temperature, and temperature of the refrigerated beer storage compartment.

The user 100 can also watch 495 the progress the GPS-enabled, refrigerated vehicle 200 makes towards the delivery destination 32, in real-time, on the GUI 30 of the end-user electronic device 10.

FIG. 8 shows the inter-related ordering method for the end-user electronic device 10, the delivery server 407 and the GPS-enabled, refrigerated vehicle 200. The user 100 possesses an end-user electronic device 10 with the user app installed. The user 100 starts the order process 157, and places an order for beer 144. The beer order 144 is communicated on the communication network 403, 405 where it is ultimately received 145 by the delivery server 407.

The delivery server 407 checks 147 the database 311 to confirm that the user 100 is at a valid delivery destination 32. If the user 100 is at a valid delivery destination 32 and the micro-brewer 51 has not exceeded the aggregate volumetric limits for both brewing and self-delivery, the delivery server 407 approves 148 the order. If the user 100 is outside of the jurisdiction 300, the beer order is denied 148. If the user 100 is at a different location than the delivery address 32, the beer order is denied 148. If the micro-brewer has met the volumetric limit for beer, the beer order is denied 148. If the micro-brewer 51 has met the volumetric limit for self-delivery, the beer order is denied 148.

The delivery server 407 communicates the decision 153 to the end-user electronic device 10. If the beer order 144 is denied, the ordering process ends 162 for the end-user electronic device 10, and the delivery server 407 waits to receive 145 another order.

If the order is approved 148, the delivery server 407 dispatches 149 a GPS-enabled, refrigerated vehicle 200. The GPS-enabled, refrigerated vehicle 200 is staged 146 in a service area 301, 302, 303, 304, 305, 306, 307. The GPS-enabled, refrigerated vehicle 200 receives the order 152 and navigates 151 to the destination 32. The user 100 is able to monitor 150 the progress of the GPS-enabled, refrigerated vehicle 200 as it delivers the beer order 144. The GPS-enabled, refrigerated vehicle 200 arrives at the destination 32 and delivers 160 the beer to the user 100 who receives the beer 161. After delivery, the order process ends for the user 100; the GPS-enabled, refrigerated vehicle 200 is staged 146, and the delivery server 407 awaits receipt of a new beer order 145.

I claim:

1. A method for self-delivering micro-brewed beer comprising the steps of:
identifying a suitable jurisdiction for self-delivery by ascertaining the maximum volume of beer that may be self-delivered;
brewing a volume of beer that does not exceed the maximum volume of beer dictated by the jurisdiction;
creating at least one service area within the jurisdiction;
locating at least one refrigerated storage depot in a logistically suitable geographic region so as to adequately service each of the service areas;
distributing beer to the at least one refrigerated storage depot;
using at least one GPS-enabled, refrigerated delivery vehicle, having a refrigerated beer-storage compartment;
loading beer from the refrigerated storage depot into the refrigerated beer-storage compartment of the at least one GPS-enabled, refrigerated delivery vehicle;
staging the at least one GPS-enabled, refrigerated delivery vehicle in a logistically advantageous position;
enabling users within the service area to order micro-brewed beer to be delivered to an address within the service area, using an end-user electronic device;
verifying that a user is eligible to receive micro-brewed beer based on age, delivery address, location of end-user electronic device, and payment;
dispatching the GPS-enabled, refrigerated vehicle most capable of fulfilling the beer delivery request;
routing the GPS-enabled, refrigerated delivery vehicle to the address, using only road networks that are legally allowable;
driving the GPS-enabled, refrigerated delivery vehicle to the address using the route provided;
arriving at the address;
confirming the identity of the user;
delivering beer to the user at the address; and
tracking the aggregate amount of beer so delivered.

2. The method for delivering micro-brewed beer in claim 1, further comprising the step of providing allowing the user to monitor the progress of GPS-enabled, refrigerated delivery vehicle to the delivery address, using a graphic user interface (“GUI”) on the end-user electronic device.

3. The method for delivering micro-brewed beer in claim 2, further comprising the step of allowing a micro-brewer to monitor the progress of GPS-enabled, refrigerated delivery vehicle to the delivery address.

4. The method for delivering micro-brewed beer in claim 3, further comprising the step of supplying auxiliary information to be displayed on the GUI of the end-user electronic device while the GPS-enabled, refrigerated delivery vehicle is proceeding to the delivery address.

5. The method for delivering micro-brewed beer in claim 4, wherein the auxiliary information includes at least one of details concerning a loyalty program; rewards available to the user for frequent beer purchases; the user's previous order history; current promotions; upcoming promotions; the estimated time of arrival of the GPS-enabled, refrigerated delivery vehicle at the delivery address; the temperature of the beer storage compartment on the GPS-enabled, refrigerated delivery vehicle; a notification that the GPS-enabled, refrigerated delivery vehicle has reached the delivery address; the ambient outdoor temperature; the average price of beer in the local area; the average delivery time in the local area for the micro-brewer's service; and trivia related to the micro-brewer, beer, and the local service area.

6. The method for delivering micro-brewed beer in claim 1, wherein the GPS-enabled, refrigerated vehicle is driven by a delivery person.

7. The method for delivering micro-brewed beer in claim 1, wherein the GPS-enabled, refrigerated vehicle is autonomously driven.

8. The method for delivering micro-brewed beer in claim 1, comprising the further step of confirming the user's identify prior to delivery of the beer.

9. The method for delivering micro-brewed beer in claim 8, wherein the user's identity is confirmed using facial recognition.

10. The method for delivering micro-brewed beer in claim 1, further comprising the step of creating compliance reports.

11. The method of delivering micro-brewed beer in claim 1, further comprising the step of collecting, monitoring, and assessing diagnostic information about the at least one GPS-enable, refrigerated delivery vehicle.

12. The method of delivering micro-brewed beer in claim 11, wherein the diagnostic information is at least one of service hours, service miles, fuel economy, engine temperature, and temperature of the refrigerated beer storage compartment.

13. The method of delivering micro-brewed beer in claim 12, further comprising the step of creating a preventative maintenance schedule for each of the at least one GPS-enabled, refrigerated vehicle.

14. The method of delivering micro-brewed beer in claim 13, further comprising the step of executing the preventative maintenance schedule for each of the at least one GPS-enabled, refrigerated vehicle.

15. The method of delivering micro-brewed beer in claim 1, wherein the logistically advantageous position is determined by at least one of the centroid of past sales for a particular service area; the minimum time to travel to expected future orders, based on population density; the centroid of the population for the service area; the minimum time to travel to prior delivery addresses, based on a weighting of their order frequency; a calendar specific event; demographic information from past sales, such as age, sex, and median income; and mapping demographic information from past sales onto the demographic information for the geographic service area as a whole.

16. A system for self-delivering micro-brewed beer comprising
a jurisdiction in which there is a volumetric limit to the amount of beer that a micro-brewer may self-distribute;
a service area within the jurisdiction;
a micro-brewery capable of producing an amount of beer less than or equal to the volumetric limit;
a refrigerated storage depot in proximity to the service area in which is stocked a portion of the beer produced by the micro-brewery;
an end-user electronic device,
wherein the end-user electronic device has an input, an output, a non-transitory memory element, a processor, a GPS chipset; a communications chipset capable of transmitting and receiving;
a GPS-enabled, refrigerated delivery vehicle having received a stock of beer from the refrigerated storage location;
wherein the GPS-enabled, refrigerated delivery vehicle has an onboard electronic device having an input, an output, a GPS chipset, a communications chipset capable of transmitting and receiving, a non-transitory memory element, and a process;
a delivery server;
wherein the delivery server has an input, an output, a non-transitory memory element, a processor, a transmitter, and a receiver;
a communication network accessible to the end-user electronic device, the onboard electronic device of the GPS-enabled, refrigerated delivery vehicle; and the delivery server;
a first computer-readable instruction set stored on the non-transitory memory element of the end-user electronic device and accessible to the processor of the end-user electronic device;
a second computer-readable instruction set stored on the non-transitory memory element of the onboard electronic device of the GPS-enabled, refrigerated delivery vehicle and accessible to the processor of the onboard electronic device of the GPS-enabled, refrigerated delivery vehicle;
a third computer-readable instruction set stored on the non-transitory memory element of the delivery server and accessible to the processor of the delivery server;
wherein an input by a user to the input of the end-user electronic device will cause the processor of the end-user electronic device to access and execute the first computer-readable instruction set so that it creates and transmits a beer delivery request, containing a delivery address;
wherein the beer delivery request is received by the delivery server;
wherein the beer delivery request acts as an input to the delivery server, causing the processor of the delivery server to access and execute the third computer-readable instruction set, allowing the processor to determine the eligibility of the user to receive beer and transmitting a beer delivery request in response to a positive determination;
wherein the onboard electronic device of the GPS-enabled, refrigerated vehicle receives the beer delivery request from the delivery server and uses it as an input to the processor of the onboard electronic device, causing the processor to access the second computer-readable instruction set, creating a route from the GPS-enabled, refrigerated vehicle's current location to the user's address; and
wherein the GPS-enabled, refrigerated vehicle travels to the user's address, using the route, and delivers the requested beer to the user.

17. The system for self-delivering micro-brewed beer in claim 16, wherein the execution of the third computer-readable instruction set in response to a beer delivery request causes the delivery server to transmit a location query to the end-user electronic device.

18. The system for self-delivering micro-brewed beer in claim 17, wherein the receipt of a location query by the end-user electronic device causes the first computer-readable instruction set to record the GPS coordinates of the end-user electronic device, as provided by the GPS chipset on the end-user electronic device, and transmit the GPS coordinates back to the delivery server.

19. The system for self-delivering micro-brewed beer in claim 18, wherein the delivery server compares the GPS coordinates of the end-user electronic device to the delivery address, to confirm that the end-user electronic device is at the delivery address.

20. The system for self-delivering micro-brewed beer in claim 19, wherein the delivery server confirms that deliver address is within a valid service area.

21. The system for self-delivering micro-brewed beer in claim 20, wherein the delivery server uses the third computer-readable instruction set to determine the user's age and ability to pay.

22. The system for self-delivering micro-brewed beer in claim 21, further comprising a plurality of service areas; a plurality of refrigerated storage depots; a plurality of GPS-enabled, refrigerated vehicles; and a plurality of end-user electronic devices.

23. The system for self-delivering micro-brewed beer in claim 22, wherein each of the plurality of service areas has an accessible refrigerated storage depot.

24. The system for self-delivering micro-brewed beer in claim 23, wherein each of the plurality of service areas has at least one of the plurality of GPS-enabled, refrigerated vehicles.

25. The system for self-delivering micro-brewed beer in claim 24, wherein, when not assigned a beer delivery request, the GPS-enabled, refrigerated vehicle will be staged at a logistically advantageous position.

26. The system for self-delivering micro-brewed beer in claim 25, wherein the logistically advantageous position is determined using one or more of the centroid of past sales for a particular service area; the minimum time to travel to expected future orders, based on population density; the centroid of the population for the service area; the minimum time to travel to prior delivery addresses, based on a weighting of their order frequency; a calendar specific event; demographic information from past sales, such as age, sex, and median income; and mapping demographic information from past sales onto the demographic information for the geographic service area as a whole.

27. The system for self-delivering micro-brewed beer in claim 26, wherein, when executed, the second computer-readable instruction set will transmit the current location of the GPS-enabled, refrigerated vehicle as it travels to the delivery address.
